(19) United States
(12) Patent Application Publication
(10) Pub. No.: US 2013/0124597 A1
(43) Pub. Date: May 16, 2013

(54) NODE AGGREGATION SYSTEM FOR IMPLEMENTING SYMMETRIC MULTI-PROCESSING SYSTEM

(71) Applicant: Huawei Technologies Co., Ltd., Shenzhen (CN)

(72) Inventors: Junfeng DIAO, Shenzhen (CN); Shaoyong WANG, Santa Clara, CA (US)

(73) Assignee: HUAWEI TECHNOLOGIES CO., LTD., Shenzhen (CN)

(21) Appl. No.: 13/732,260

(22) Filed: Dec. 31, 2012

Related U.S. Application Data
(63) Continuation of application No. PCT/CN2011/078240, filed on Aug. 11, 2011.

(51) Int. Cl. H04L 29/08

(52) U.S. Cl. CPC H04L 67/02
USPC 709/201

(57) ABSTRACT

Embodiments of the present invention provide a node aggregation system for implementing a symmetric multi-processing system. The system includes at least one node aggregation module, at least one service network interface module and at least one computing node cluster, where the computing node cluster includes at least one computing node; the computing node cluster forms a computing resource pool, and is adapted to process a data service; the node aggregation module constitutes an aggregation network domain, and is connected to all the computing nodes in the computing node cluster through a first interface; and the service network interface module constitutes a service network domain, and is connected to all the computing nodes in the computing node cluster through a second interface, and connected to an external input/output device through several interfaces different from the second interface.

### CROSS-REFERENCE TO RELATED APPLICATIONS

This application is a continuation of International Application No. PCT/CN2011/078240, filed on Aug. 11, 2011, which is hereby incorporated by reference in their entireties.

### FIELD OF THE INVENTION

Embodiments of the present invention relate to the field of communications, and in particular, to a node aggregation system for implementing a symmetric multi-processing system.

### BACKGROUND OF THE INVENTION

A symmetric multi-processing (Symmetric Multi-Processing, SMP) system, as a fat node in cloud computing and a node for entering a data center, is an important evolution trend, and currently all mainstream IT manufacturers provide large-scale SMP systems. In view of product form and architecture, the large-scale SMP systems are relatively unique, which is mainly embodied in that: a whole system ranging from computing nodes to non uniform memory access (Non Uniform Memory Access, NUMA) network hardware is bundled to products of a certain manufacturer, resulting high purchasing cost, limited system scalability (32-way to 64-way at most), single-purpose and fixed service types and the like.

As shown in FIG. 1-a, it is a schematic diagram showing connection of computing nodes in an SMP system provided in the prior art. The SMP system includes 8 computing nodes, and it may be seen from the figure that, a full interconnection topology is adopted among the 8 computing nodes, that is, each computing node is directly connected to the other 7 computing nodes in pairs. Each computing node of the system includes 4 central processing units (Central Processing Unit, CPU), where the CPUs are all manufactured by a same manufacturer and adopt the full interconnection topology (therefore, the system supports 32-way processors at most), where as shown in FIG. 1-b, each CPU is connected to a CPU input/output (Input/Output, IO) bus adapter (Adaptor) through a CPU IO bus, and is connected to an external IO expansion subrack (an IO expansion subrack has multiple specifications, and is mainly used for connecting an external PCI-E card or hard disk) through the CPU IO bus adapter. The IO structure of the computing node exemplified in FIG. 1-b is not globally shared, that is, each CPU is corresponding to an IO device of each CPU itself, and if other CPUs need to access an IO device corresponding to a CPU, they need to pass through the CPU. For example, if a CPU2 needs to access an IO device (for example, an IO expansion subrack 1) of a CPU1, data or information needs to first pass through the CPU1, and arrive at a CPU IO bus adapter, which is connected to the CPU1, through a CPU IO bus between the CPU1 and the IO expansion subrack 1, then the access to the IO expansion subrack 1 can be implemented.

Because the full interconnection topology is adopted among the CPUs, the CPU of the SMP system provided in the prior art inevitably has many interconnection interfaces, which incurs high design difficulty, and makes it difficult to enlarge the system scale; on the other hand, because the IO structure of the CPU in the SMP system provided in the prior art is not globally shared, if other nodes need to access an IO device, they need to pass through a node corresponding to the IO device, which therefore increases the delay and affects the overall performance of the system. In view of an operating system (Operating System, OS), if an OS needs to access resources of a certain IO device, the OS needs to know a node corresponding to the IO device, and as a result, the design of the OS needs to be tightly coupled to hardware of a specific device, and therefore it is difficult to achieve a universal design.

### SUMMARY OF THE INVENTION

Embodiments of the present invention provide a node aggregation system for implementing a symmetric multi-processing system, so as to achieve flexible configuration of the scale of the SMP system and global sharing of input/output resources.

An embodiment of the present invention provides a node aggregation system for implementing a symmetric multi-processing system, which includes at least one node aggregation module, at least one service network interface module and at least one computing node cluster, where the computing node cluster includes at least one computing node;

the computing node cluster forms a computing resource pool, and is adapted to process a data service;

the node aggregation module constitutes an aggregation network domain, and is connected to all computing nodes in the computing node cluster through a first interface Interf1; and

the service network interface module constitutes a service network domain, and is connected to all the computing nodes in the computing node cluster through a second interface Interf2, and connected to an external input/output device through several interfaces different from the second interface Interf2.

An embodiment of the present invention provides a node aggregation system for implementing a symmetric multi-processing system, which includes at least one node aggregation module, an input/output device and at least one computing node cluster, where the computing node cluster includes at least one computing node;

the computing node cluster forms a computing resource pool, and is adapted to process a data service; and

the node aggregation module constitutes an aggregation network domain, and is connected to all the computing nodes in the computing node cluster through a same interface, and connected to the input/output device through the same interface or other interfaces different from the converged interface.

It may be known from the node aggregation system for implementing a symmetric multi-processing system shown above that, because the aggregation network plane and the service plane are separated, and are connected to all the computing nodes in the computing node cluster through a converged interface seperately, that is, interfaces of the aggregation network plane and the service network plane use the same interface, so that multiple computing nodes may be combined through the aggregation network plane to form a large SMP system, thereby achieving a large computing resource pool; in addition, a separated service plane is connected to all the computing nodes in the computing node cluster through only one converged interface, which also achieves global sharing of IO resources, and reduces the delay of the computing node when the computing node accesses IO resources, thereby improving the overall performance of the system.

### BRIEF DESCRIPTION OF THE DRAWINGS

To illustrate the technical solutions according to the embodiments of the present invention more clearly, the accompanying drawings for describing the prior art or the embodiments are introduced briefly in the following. Apparently, the accompanying drawings in the following description are some embodiments of the present invention, and persons skilled in the art may obtain other drawings according to the accompanying drawings.

FIG. 1-a is a schematic diagram showing connection of computing nodes in an SMP system provided in the prior art;

FIG. 1-b is a schematic structural diagram of an SMP system provided in the prior art;

FIG. 2-a is a schematic structural diagram of a node aggregation system for implementing a symmetric multi-processing system provided in an embodiment of the present invention;

FIG. 2-b is a schematic structural diagram of a node aggregation system for implementing a symmetric multi-processing system provided in another embodiment of the present invention;

FIG. 3-a is a schematic structural diagram of a node aggregation system for implementing a symmetric multi-processing system provided in another embodiment of the present invention;

FIG. 3-b is a schematic structural diagram of a node aggregation system for implementing a symmetric multi-processing system provided in another embodiment of the present invention;

FIG. 3-c is a schematic structural diagram of a node aggregation system for implementing a symmetric multi-processing system provided in another embodiment of the present invention;

FIG. 3-d is a schematic structural diagram of a node aggregation system for implementing a symmetric multi-processing system provided in another embodiment of the present invention;

FIG. 4-a is a schematic structural diagram of a node aggregation system for implementing a symmetric multi-processing system provided in another embodiment of the present invention;

FIG. 4-b is a schematic structural diagram of a node aggregation system for implementing a symmetric multi-processing system provided in another embodiment of the present invention;

FIG. 4-c is a schematic structural diagram of a node aggregation system for implementing a symmetric multi-processing system provided in another embodiment of the present invention;

FIG. 4-d is a schematic structural diagram of a node aggregation system for implementing a symmetric multi-processing system provided in another embodiment of the present invention; and

FIG. 4-e is a schematic structural diagram of a node aggregation system for implementing a symmetric multi-processing system provided in another embodiment of the present invention.

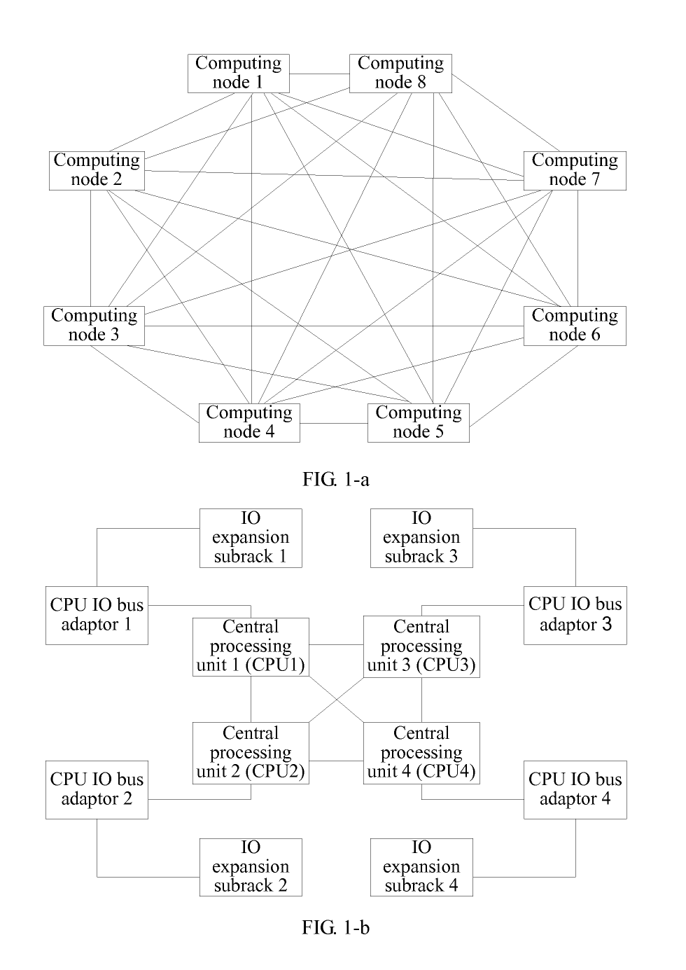

### DETAILED DESCRIPTION OF THE EMBODIMENTS

Embodiments of the present invention provide a node aggregation system for implementing a symmetric multi-processing system, so as to achieve flexible configuration of the scale of the SMP system and global sharing of input/output resources.

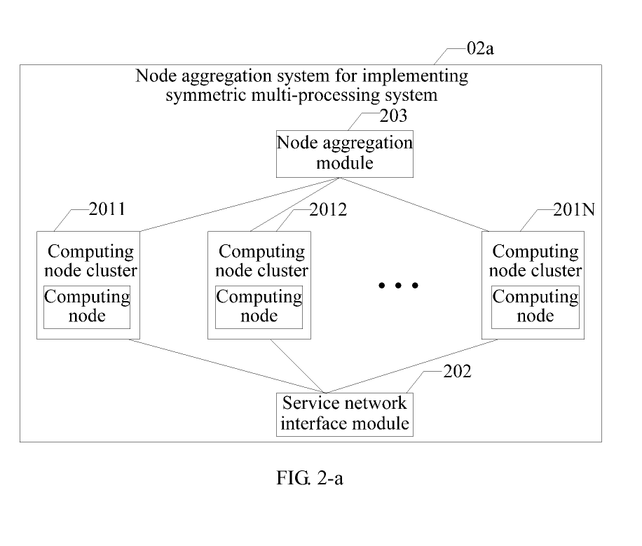

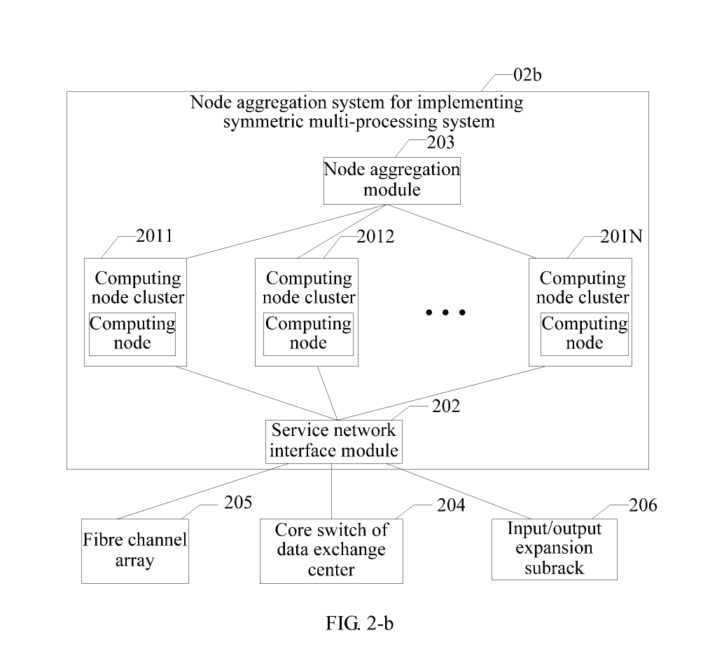

FIG. 2-a is a schematic structural diagram of a node aggregation system for implementing a symmetric multi-processing system provided in an embodiment of the present invention. In order to facilitate description, only parts related to the embodiment of the present invention are shown.

The node aggregation system 02a for implementing a symmetric multi-processing system shown in FIG. 2-a includes at least one node aggregation module 203, at least one service network interface module 202 and a computing node cluster 2011, a computing node cluster 2012, . . . , and a computing node cluster 201N, that is, the node aggregation system 02 for implementing a symmetric multi-processing system at least includes one computing node cluster, and the computing node cluster at least includes one computing node. It may be understood that, each computing node includes a processor and memory resources. The computing node cluster forms a computing resource pool, and is adapted to process a data service; the node aggregation module 203 constitutes an aggregation network plane, and is connected to all computing nodes in the computing node cluster through a converged first interface Interf1, that is, all the computing nodes in the computing node cluster are connected to the node aggregation module 203 through only one interface Interf1; and the service network interface module 202 constitutes a service network plane, and is connected to all the computing nodes in the computing node cluster through a converged second interface Interf2, that is, all the computing nodes in the computing node cluster are connected to the service network interface module 202 through only one interface Interf2, and the service network interface module 202 is connected to an external input/output device through the converged interface Interf2 or several interfaces different from the converged interface Interf2. In the embodiment provided in the present invention, the service network interface module 202 has functions similar to those of a switch (Switch) and a bridge (Bridge) of the service plane. The service network interface module 202 can be connected to each computing node through the converged interface Interf2 at one side thereof, and provide, according to a demand, various interfaces at an external side thereof for connecting an external IO device, which includes, but is not limited to, a core switch of a data center and a fibre channel (Fibre Channel, FC) array. Because the converged interface Interf2, which is at the side of the service network interface module 202 and connected to the computing node, is different from the interfaces at the external side for connecting an FC array, PCI-E, Ethernet or the like, the service network interface module 202 definitely possesses an interface conversion function of a bridge.

In the implementation of the present invention, an aggregation network domain is also referred to as an aggregation network plane, and the so-called “aggregation network plane” is an abstraction of a “layer” or “plane” of the node aggregation module, and is adapted for that the processer connects multiple computing nodes through tight coupling so as to form a large system The aggregation network plane generally does not provide interfaces for the outside of the node aggregation system, and requires high bandwidth and low delay. A service network domain is also referred to as a service network plane, the “service network plane” is an abstraction of a “layer” or “plane” of the node aggregation module, and the service network plane is adapted for the node aggregation system to provide IO links for the outside, and through the service network plane, the node aggregation system performs IO interaction of service data with the outside of the system, for example, the service network plane is connected to a switch of a data center, which may enable the node aggregation system to communicate with the outside, or the service network plane is connected to a disk array. Different from the aggregation network plane, the service network plane generally does not have a high requirement on delay.

It should be noted that, in this embodiment and other embodiments of the present invention, when the number of the node aggregation module 203 or the service network interface module 202 is more than one, one node aggregation module 203 or one service network interface module 202 may be used as an active node aggregation module or an active service network interface module, with other node aggregation modules or service network interface modules being used as standby node aggregation modules or standby service network interface modules.

In the embodiment of the present invention, the computing resource pool is a core module, and the computing node cluster is grouped mainly according to physical installation sites (for example, a cabinet position in a data center), or grouped according to integrated functions and physical installation sites. The aggregation network plane constituted by the node aggregation module 203 is adapted to tightly couple multiple computing nodes. Generally, each computing node includes 2 to 4 central processors, and the central processors in the nodes are connected to the aggregation network plane through a node controller (Node Controller, NC) Compared with the prior art where the SMP system adopting the full interconnection topology structure among the CPUs can only support 32-way processors at most, in the SMP system provided in the embodiment of the present invention, the node aggregation module 203 may aggregate the central processors in the computing nodes to form a large system, for example, a 32-way or 64-way processor system, so that a large computing resource pool may be achieved, and the scale of the SMP system may be flexibly configured according to demands. The service network plane constituted by the service network interface module 202 is adapted for the computing node to provide input output (Input Output, IO) links for the outside, and may implement IO interaction of service data with the outside of the system through a switch device of the service plane, for example, be connected to a switch in a data center to communicate with the outside.

In the node aggregation system 02a for implementing a symmetric multi-processing system shown in FIG. 2-a, the external input/output device may include a core switch 204 of a data exchange center, a fibre channel array 205 and an input/output expansion subrack 206, as in a node aggregation system 02b for implementing a symmetric multi-processing system provided in another embodiment shown in FIG. 2-b. The fibre channel (Fibre Channel, FC) array 205 is mainly adapted for a storage area network (Storage Area Network, SAN).

It should be noted that, from a perspective of the system, the aggregation network plane generally does not provide interfaces for the outside, and the service network plane needs to perform IO data interaction with the outside, for example, perform IO data interaction with an Ethernet switch; the aggregation network plane requires high bandwidth and low delay, and the service network plane requires high bandwidth, but does not have a high requirement on delay.

In the node aggregation system for implementing a symmetric multi-processing system shown in FIG. 2-a or FIG. 2-b, a first computing node in the computing node cluster includes at least one first central processor of the same type, and a second computing node in the computing node cluster includes at least one second central processor of the same type, that is, one computing node in the computing node cluster 2011 includes at least one central processor of the same type (for example, an Intel x86 processor), and another computing node in the computing node cluster 2011 includes at least one central processor of the same type (for example, an ARM processor). In other words, each computing node in the computing node cluster 2011 may include central processors of different types, which is also similar in other computing node clusters. Because the central processors of the computing nodes are not bundled to one type, the symmetric multi-processing system provided in the embodiment of the present invention may meet various service demands.

In the node aggregation system for implementing a symmetric multi-processing system shown in FIG. 2-a or FIG. 2-b, the converged interface Interf1 between the node aggregation module 203 and all the computing nodes in the computing node cluster is a private interface or an InfiniBand interface.

It may be known from the node aggregation system for implementing a symmetric multi-processing system shown in FIG. 2-a or FIG. 2-b that, because the aggregation network plane and the service plane are separated, and are connected to all the computing nodes in the computing node cluster through a converged interface seperately, that is, interfaces of the aggregation network plane and the service network plane use the same interface, so that multiple computing nodes may be combined through the aggregation network plane to form a large SMP system, thereby achieving a large computing resource pool; in addition, a separated service plane is connected to all the computing nodes in the computing node cluster through only one converged interface, which also achieves global sharing of IO resources, and reduces the delay of the computing node when the computing node accesses IO resources, thereby improving the overall performance of the system.

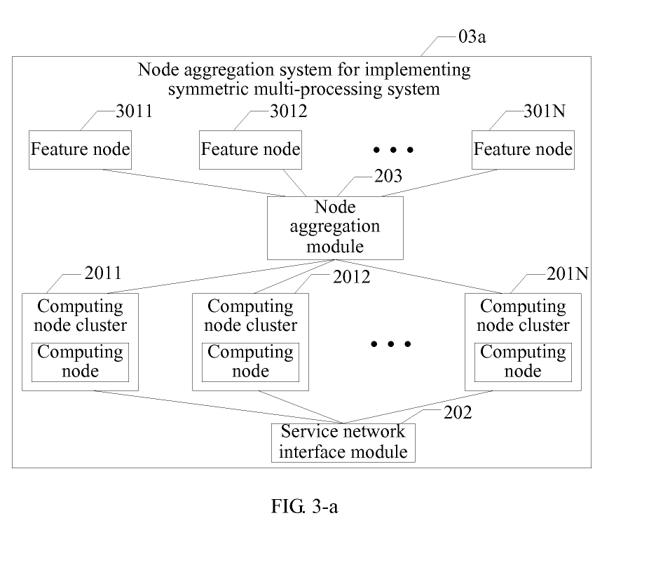

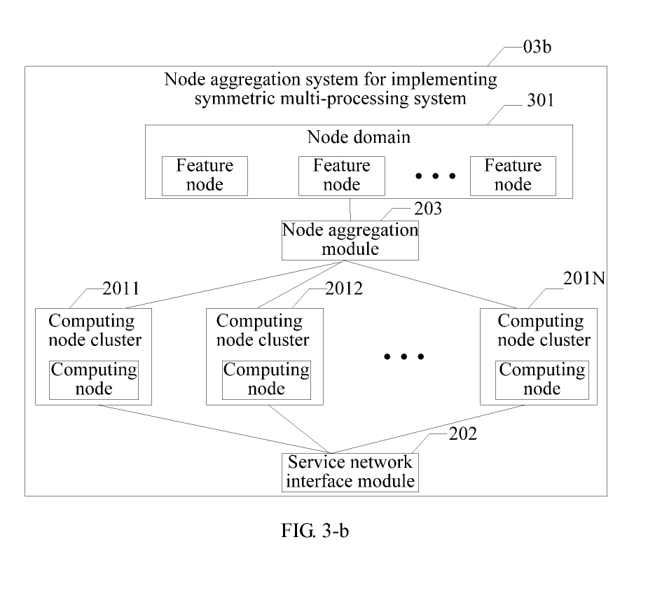

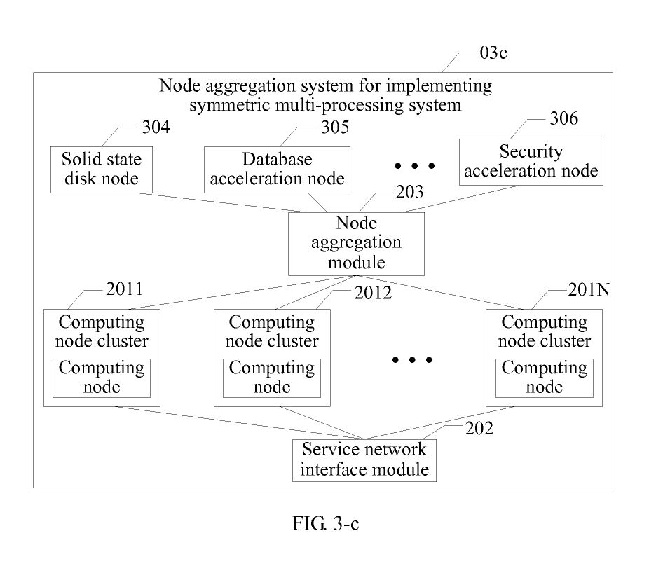

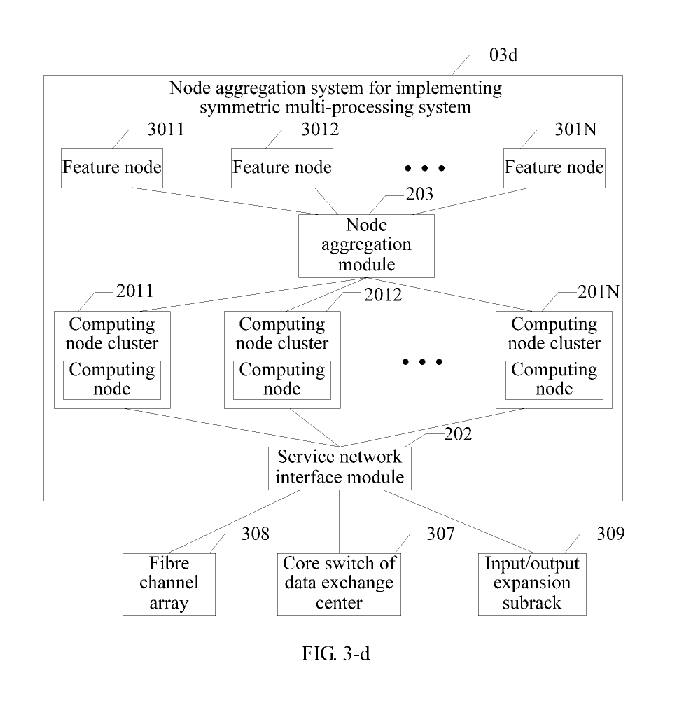

FIG. 3-a is a schematic structural diagram of a node aggregation system for implementing a symmetric multi-processing system provided in another embodiment of the present invention. In order to facilitate description, only parts related to the embodiment of the present invention are shown.

The node aggregation system 03a for implementing a symmetric multi-processing system shown in FIG. 3-a not only includes the at least one node aggregation module 203, the at least one service network interface module 202 and the computing node cluster 2011, the computing node cluster 2012, . . . , and the computing node cluster 201N that are shown in FIG. 2-a or FIG. 2-b, but also includes several feature nodes, for example, includes a feature node 3011, a feature node 3012, . . . , and a feature node 301N. Similar to the embodiment shown in FIG. 2-a or FIG. 2-b, the node aggregation system 03a for implementing a symmetric multi-processing system at least includes one computing node cluster, and the computing node cluster at least includes one computing node. The computing node cluster forms a computing resource pool, and is adapted to process a data service; the node aggregation module 203 constitutes an aggregation network plane, and is connected to all the computing nodes in the computing node cluster through a converged interface Interf1, that is, all the computing nodes in the computing node cluster are connected to the node aggregation module 203 through only one interface Interf1; and the service network interface module 202 constitutes a service network plane, and is connected to all the computing nodes in the computing node cluster through a converged second interface Interf2, that is, all the computing nodes in the computing node cluster are connected to the service network interface module 202 through only one interface Interf2, and the service network interface module 202 is connected to an external input/output device through the converged second interface Interf2 or several interfaces different from the converged second interface Interf2. In the embodiment provided in the present invention, the service network interface module 202 has functions similar to those of a switch (Switch) and a bridge (Bridge) of the service plane. The service network interface module 202 can be connected to each computing node through the converged interface Interf2 at one side thereof, and provide, according to a demand, various interfaces at an external side thereof for connecting an external IO device, which includes, but is not limited to, a core switch of a data center and an FC array. Because the converged interface Interf2, which is at the side of the service network interface module 202 and connected to the computing node, may be different from the interfaces at the external side for connecting an FC array, PCI-E, Ethernet or the like, the service network interface module 202 may possess an interface conversion function of the bridge.

In the node aggregation system 03a for implementing a symmetric multi-processing system shown in FIG. 3-a, the computing resource pool is a core module, and the computing node cluster is grouped mainly according to physical installation sites (for example, a cabinet position in a data center), or grouped according to integrated functions and physical installation sites. The aggregation network plane constituted by the node aggregation module 203 is adapted to tightly couple multiple computing nodes. Generally, each computing node includes 2 to 4 central processors, and the central processors in the nodes are connected to the aggregation network plane through a node controller (Node Controller, NC). Compared with the prior art where the SMP system adopting the full interconnection topology structure among the CPUs can only support 32-way processors at most, in the SMP system provided in the embodiment of the present invention, the node aggregation module 203 may aggregate the central processors in the computing nodes to form a large system, for example, a 32-way or 64-way processor system, so that a large computing resource pool may be achieved, and the scale of the SMP system may be flexibly configured according to demands. The service network plane constituted by the service network interface module 202 is adapted for the computing node to provide input output (Input Output, IO) links for the outside, and may implement IO interaction of service data with the outside of the system through a switch device of the service plane, for example, be connected to a switch in a data center to communicate with the outside.

The feature node 3011, the feature node 3012, . . . , and the feature node 301N are adapted to accelerate the process of processing the data service by the computing node of the computing node cluster in the node aggregation system 03a for implementing a symmetric multi-processing system or add additional functions to the node aggregation system. In other words, the computing node implements the basic data processing function of the system, and meanwhile, in order to enhance the system features, modules like the feature nodes are introduced. In the embodiment of the present invention, the feature node may have functions of “database acceleration” and “global mirror”, is adapted to accelerate computation of the system or add value to the system, and adds some system functions in addition to the functions provided by the computing node cluster, which presents flexibility and scalability. The so-called “additional functions” refer to the functions provided by the feature node, and may continuously evolve and be expanded according to customer demands. The node aggregation module 203 is connected, through the converged first interface Interf1 or several interfaces different from the converged first interface Interf1, to the feature node in the node aggregation system 03a for implementing a symmetric multi-processing system.

In one embodiment of the present invention, several feature nodes in the symmetric multi-processing system shown in FIG. 3-a may form a node domain 301, as in a node aggregation system 03b for implementing a symmetric multi-processing system provided in an embodiment of the present invention shown in FIG. 3-b. The so-called node domain may be a domain constituted by multiple feature nodes together, the domain is also capable of implementing a particular function, and the node domain is not limited to one type of feature node. In other words, the node domain is a functional module combined by multiple feature nodes, and can also be applied to accelerate the process of processing the data service by the computing node in the node aggregation system or add a function to the system, and different from the feature node, the node domain presents to the outside a functional module having more functions than those of a single feature node. For example, for application of a database acceleration node (which is a “feature node”), with the expansion of the system, one database acceleration node may become insufficient for certain application software, and multiple database acceleration nodes are required to form a “database acceleration node domain” (which is a “node domain”) to support the application.

In one embodiment of the present invention, the feature node in the node aggregation system for implementing a symmetric multi-processing system shown in FIG. 3-a or FIG. 3-b may be one or more of a solid state disk (Solid State Disk, SSD) node, a database (DataBase, DB) acceleration node and a security acceleration node. A node aggregation system for implementing a symmetric multi-processing system provided in an embodiment of the present invention shown in FIG. 3-c includes a solid state disk node 304, a database acceleration node 305 and a security acceleration node 306. The function of the solid state disk node 304 may be determined according to customer demands, and is, for example, adapted for system mirror and system cache (Cache); the database acceleration node 305 may be adapted to, during processing of a database service, assist the computing node to process particular computing functions, for example, to accelerate decimal computation, and the security acceleration node 305 may assist the computing node in the computing node cluster to process some security algorithms, for example, to accelerate a key algorithm. In the embodiment of the present invention, the feature node is not limited to the SSD node, the DB acceleration node and the security acceleration node, and in principle, any node functioning as a value-added component of the system or having a computation acceleration function may be connected to the node aggregation module 203.

It should be understood that, several of the solid state disk node 304, the database acceleration node 305 and the security acceleration node 306 that are shown in FIG. 3-c may form one or more node domains, so as to implement a particular function.

In the node aggregation system for implementing a symmetric multi-processing system shown in FIG. 3-a, FIG. 3-b or FIG. 3-c, the external input/output device may include a core switch 307 of a data exchange center, a fibre channel array 308 and an input/output expansion subrack 309, as in a node aggregation system 03d for implementing a symmetric multi-processing system provided in another embodiment shown in FIG. 3-d. The fibre channel (Fibre Channel, FC) array 308 is mainly adapted for a storage area network (Storage Area Network, SAN).

In the node aggregation system for implementing a symmetric multi-processing system shown in FIG. 3-a to FIG. 3-d, a first computing node in the computing node cluster includes at least one first central processor of the same type, and a second computing node in the computing node cluster includes at least one second central processor of the same type, that is, one computing node in the computing node cluster 2011 includes at least one central processor of the same type (for example, an Intel x86 processor), and another computing node in the computing node cluster 2011 includes at least one central processor of the same type (for example, an ARM processor). In other words, the computing nodes in the computing node cluster 2011 may include central processors of different types, which is also true in other computing node clusters. Because the central processors of the computing nodes are not bundled to one type, the symmetric multi-processing system provided in the embodiment of the present invention may meet various service demands.

In the node aggregation system for implementing a symmetric multi-processing system shown in FIG. 3-a to FIG. 3-d, the converged interface Interf1 between the node aggregation module 203 and all the computing nodes in the computing node cluster is a private interface or an InfiniBand interface.

It may be known from the node aggregation system for implementing a symmetric multi-processing system shown in FIG. 3-a to FIG. 3-d that, because the aggregation network plane and the service plane are separated, and are connected to all the computing nodes in the computing node cluster through a converged interface seperately, that is, interfaces of the aggregation network plane and the service plane use the same interface, so that multiple computing nodes may be combined through the aggregation network plane to form a large SMP system, thereby achieving a large computing resource pool; the separated service plane is connected to all the computing nodes in the computing node cluster through only one converged interface, which also achieves global sharing of IO resources, and reduces the delay of the computing node when the computing node accesses IO resources, thereby improving the overall performance of the system; in addition, adding the feature node may also enable the symmetric multi-processing system provided in the embodiment of the present invention to realize special functions of accelerating computation of the computing node and assisting the computing node to process a security algorithm.

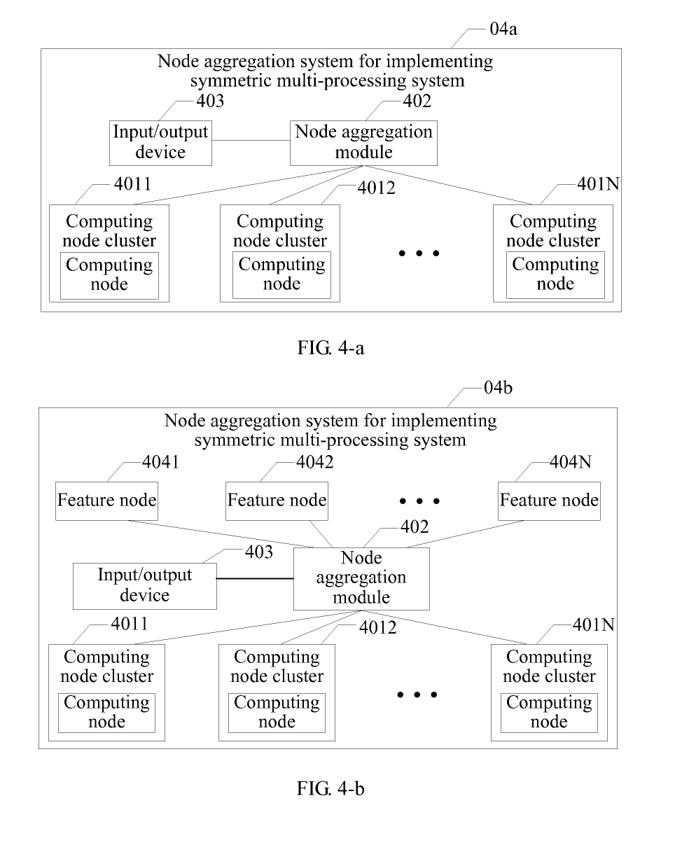

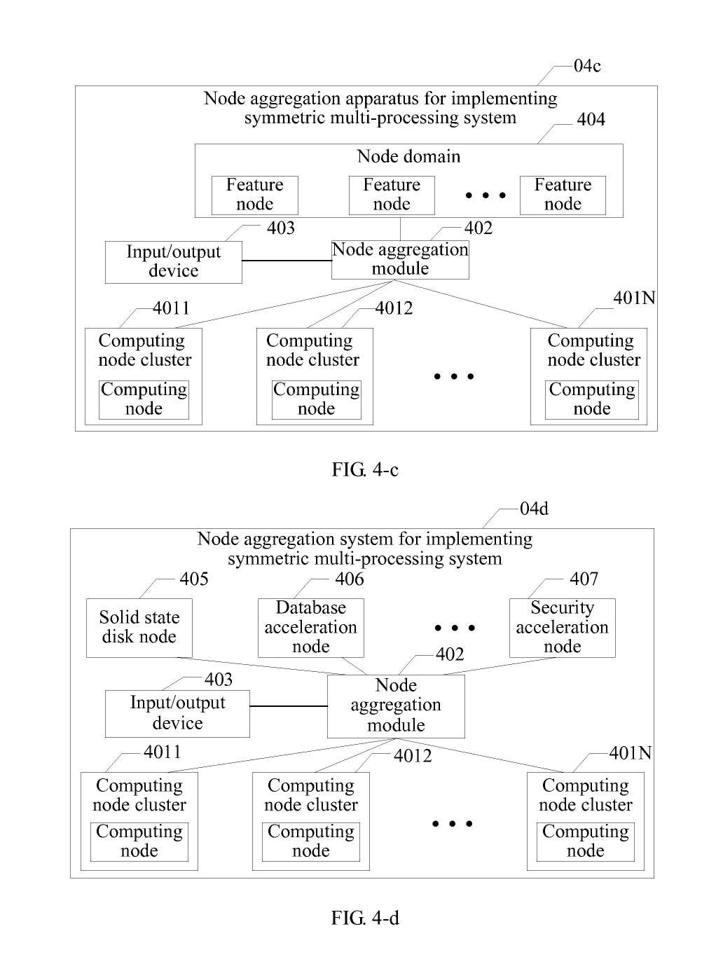

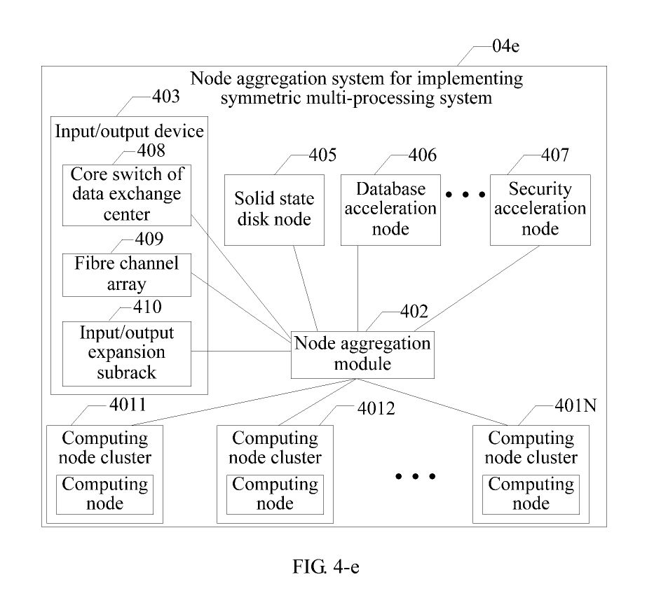

FIG. 4-a is a schematic structural diagram of a node aggregation system for implementing a symmetric multi-processing system provided in another embodiment of the present invention. In order to facilitate description, only parts related to the embodiment of the present invention are shown.

The node aggregation system 04a for implementing a symmetric multi-processing system shown in FIG. 4-a includes at least one node aggregation module 402, an input/output device 403 and a computing node cluster 4011, a computing node cluster 4012, . . . , and a computing node cluster 401N, that is, the node aggregation system 04a for implementing a symmetric multi-processing system includes one computing node cluster at least, and the computing node cluster includes one computing node at least. The computing node cluster forms a computing resource pool, and is adapted to process a data service; the node aggregation module 402 constitutes an aggregation network plane, and is connected to all the computing nodes in the computing node cluster through one same interface and connected to the input/output device 403 through several interfaces different from a converged interface, that is, all the computing nodes in the computing node cluster are connected to the node aggregation module 402 through only one interface, and the node aggregation module 402 is connected to the input/output device 403 through the same interface or other interfaces different from the converged interface.

It should be noted that, in this embodiment and other embodiments of the present invention, when the number of the node aggregation module 402 is more than one, one node aggregation module 402 may be used as an active node aggregation module, with other node aggregation modules being used as standby node aggregation modules.

In the embodiment shown in FIG. 4-a, the computing resource pool is a core module, and the computing node cluster is grouped mainly according to physical installation sites (for example, a cabinet position in a data center), or grouped according to integrated functions and physical installation sites. The aggregation network plane constituted by the node aggregation module 402 is adapted to tightly couple multiple computing nodes. Generally, each computing node includes 2 to 4 central processors, and the central processors in the nodes are connected to the aggregation network plane through a node controller (Node Controller, NC). Compared with the prior art where the SMP system adopting the full interconnection topology structure among the CPUs can only support 32-way processors at most, in the SMP system provided in the embodiment of the present invention, the node aggregation module 402 may aggregate the central processors in the computing nodes to form a large system, for example, a 32-way or 64-way processor system, so that a large computing resource pool may be achieved, and the scale of the SMP system may be flexibly configured according to demands.

In the node aggregation system for implementing a symmetric multi-processing system shown in FIG. 4-a, a first computing node in the computing node cluster includes at least one first central processor of the same type, and a second computing node in the computing node cluster includes at least one second central processor of the same type, that is, one computing node in the computing node cluster 4011 includes at least one central processor of the same type (for example, an Intel x86 processor), and another computing node in the computing node cluster 4011 includes at least one central processor of the same type (for example, an ARM processor). In other words, the computing nodes in the computing node cluster 4011 may include central processors of different types, which is also true in other computing node clusters. Because the central processors of the computing nodes are not bundled to one type, the symmetric multi-processing system provided in the embodiment of the present invention may meet various service demands.

In the node aggregation system for implementing a symmetric multi-processing system shown in FIG. 4-a, the converged interface between the node aggregation module 402 and all the computing nodes in the computing node cluster is a private interface or an InfiniBand interface.

In the node aggregation system for implementing a symmetric multi-processing system shown in FIG. 4a, the input/output device 403 may include a core switch of a data exchange center, a fibre channel array and an input/output expansion subrack, where the fibre channel (Fibre Channel, FC) array is mainly adapted for a storage area network (Storage Area Network, SAN).

It may be known from the node aggregation system for implementing a symmetric multi-processing system shown in FIG. 4-a that, because interfaces of the aggregation network plane use the same interface, multiple computing nodes may be combined through the aggregation network plane to form a large SMP system, thereby achieving a large computing resource pool; in addition, the aggregation network plane is connected to all the computing nodes in the computing node cluster through only one converged interface, which also achieves global sharing of IO resources, and reduces the delay of the computing node when the computing node accesses IO resources, thereby improving the overall performance of the system.

The node aggregation system 04a for implementing a symmetric multi-processing system shown in FIG. 4-a not only includes the node aggregation module 402, the input/output device 403 and the computing node cluster 4011, the computing node cluster 4012, . . . , and the computing node cluster 401N, but also includes several feature nodes, for example, includes a feature node 4041, a feature node 4042, . . . , and a feature node 404N, as in a node aggregation system 04b for implementing a symmetric multi-processing system provided in an embodiment of the present invention shown in FIG. 4-b. Similar to the embodiment shown in FIG. 4-a, the node aggregation system 04b for implementing a symmetric multi-processing system at least includes one computing node cluster, and the computing node cluster at least includes one computing node. The computing node cluster forms a computing resource pool, and is adapted to process a data service; the node aggregation module 402 constitutes an aggregation network plane, and is connected to all the computing nodes in the computing node cluster through one same interface and connected to the input/output device 403 through several interfaces different from the same interface, that is, all the computing nodes in the computing node cluster are connected to the node aggregation module 402 through only one interface, and the node aggregation module 402 is connected to the input/output device 403 through several interfaces different from the converged interface.

In the node aggregation system 04b for implementing a symmetric multi-processing system shown in FIG. 4-b, the computing resource pool is a core module, and the computing node cluster is grouped mainly according to physical installation sites (for example, a cabinet position in a data center), or grouped according to integrated functions and physical installation sites. The aggregation network plane constituted by the node aggregation module 402 is adapted to tightly couple multiple computing nodes. Generally, each computing node includes 2 to 4 central processors, and the central processors in the nodes are connected to the aggregation network plane through a node controller (Node Controller, NC). Compared with the prior art where the SMP system adopting the full interconnection topology structure among the CPUs can only support 32-way processors at most, in the SMP system provided in the embodiment of the present invention, the node aggregation module 402 may aggregate the central processors in the computing nodes to form a large system, for example, a 32-way or 64-way processor system, so that a large computing resource pool may be achieved, and the scale of the SMP system may be flexibly configured according to demands.

The feature node 4041, the feature node 4042, . . . , and the feature node 404N are adapted to accelerate the process of processing the data service by the computing node of the computing node cluster in the symmetric multi-processing system 04a and add additional functions to the node aggregation system. The node aggregation module 402 is connected to the feature node in the node aggregation system 04a for implementing a symmetric multi-processing system through several interfaces different from the converged interface.

In the node aggregation system for implementing a symmetric multi-processing system shown in FIG. 4-b, a first computing node in the computing node cluster includes at least one first central processor of the same type, and a second computing node in the computing node cluster includes at least one second central processor of the same type, that is, one computing node in the computing node cluster 4011 includes at least one central processor of the same type (for example, an Intel x86 processor), and another computing node in the computing node cluster 4011 includes at least one central processor of the same type (for example, an ARM processor). In other words, the computing nodes in the computing node cluster 4011 may include central processors of different types, which is also true in other computing node clusters. Because the central processors of the computing nodes are not bundled to one type, the symmetric multi-processing system provided in the embodiment of the present invention may meet various service demands.

In one embodiment of the present invention, several feature nodes in the node aggregation system for implementing a symmetric multi-processing system shown in FIG. 4-b may form a node domain 404, as in a node aggregation system 04c for implementing a symmetric multi-processing system provided in an embodiment of the present invention shown in FIG. 4-c. The so-called node domain may be a domain constituted by multiple feature nodes together, the domain is also capable of implementing a particular function, and the node domain is not limited to one type of feature node. In other words, the node domain is a functional module combined by multiple feature nodes, and can also be applied to accelerate the process of processing the data service by the computing node in the node aggregation system or add a function to the system, and different from the feature node, the node domain presents to the outside a functional module having more functions than those of a single feature node.

In one embodiment of the present invention, the feature node in the node aggregation system for implementing a symmetric multi-processing system shown in FIG. 4-b or FIG. 4-c may be one or more of a solid state disk (Solid State Disk, SSD) node, a database (DataBase, DB) acceleration node and a security acceleration node. The node aggregation system 04d for implementing a symmetric multi-processing system provided in the embodiment of the present invention shown in FIG. 4-d includes a solid state disk node 405, a database acceleration node 406 and a security acceleration node 407. The function of the solid state disk node 405 may be determined according to customer demands, and is, for example, adapted for system mirror and system cache (Cache), the database acceleration node 406 may be adapted to assist the computing node to process particular computing functions, for example, to accelerate decimal computation, during processing of a database service, and the security acceleration node 407 may assist the computing node in the computing node cluster to process some security algorithms, for example, to accelerate a key algorithm. In the embodiment of the present invention, the feature node is not limited to the SSD node, the DB acceleration node and the security acceleration node, and in principle, any node functioning as a value-added component of the system or having a computation acceleration function may be connected to the node aggregation module 402.

It should be understood that, several of the solid state disk node 405, the database acceleration node 406 and the security acceleration node 407, which are shown in FIG. 4-d, and so on may form one or more node domains, so as to implement a particular function.

In the node aggregation system for implementing a symmetric multi-processing system shown in FIG. 4-b to FIG. 4-d, the input/output device 403 may include a core switch 408 of a data exchange center, a fibre channel array 409 and an input/output expansion subrack 410, as in a node aggregation system 04e for implementing a symmetric multi-processing system provided in another embodiment shown in FIG. 4-e. The fibre channel (Fibre Channel, FC) array 409 is mainly adapted for a storage area network (Storage Area Network, SAN).

In the node aggregation system for implementing a symmetric multi-processing system shown in FIG. 4-b to FIG. 4-e, a first computing node in the computing node cluster includes at least one first central processor of the same type, and a second computing node in the computing node cluster includes at least one second central processor of the same type, that is, one computing node in the computing node cluster 4011 includes at least one central processor of the same type (for example, an Intel x86 processor), and another computing node in the computing node cluster 4011 includes at least one central processor of the same type (for example, an ARM processor). In other words, the computing nodes in the computing node cluster 4011 may include central processors of different types, which is also true in other computing node clusters. Because the central processors of the computing nodes are not bundled to one type, the symmetric multi-processing system provided in the embodiment of the present invention may meet various service demands.

In the node aggregation system for implementing a symmetric multi-processing system shown in FIG. 4-b to FIG. 4-e, the converged interface between the node aggregation module 402 and all the computing nodes in the computing node cluster is a private interface or an InfiniBand interface.

It may be known from the node aggregation system for implementing a symmetric multi-processing system shown in FIG. 4-b to FIG. 4-e that, because interfaces of the aggregation network plane use the same interface, multiple computing nodes may be combined through the aggregation network plane to form a large SMP system, thereby achieving a large computing resource pool; the aggregation network plane is connected to all the computing nodes in the computing node cluster through only one converged interface, which also achieves global sharing of IO resources, and reduces the delay of the computing node when the computing node accesses IO resources, thereby improving the overall performance of the system; in addition, adding the feature node may also enable the symmetric multi-processing system provided in the embodiment of the present invention to realize special functions of accelerating computation of the computing node and assisting the computing node to process a security algorithm.

The node aggregation system for implementing a symmetric multi-processing system provided in the present invention is described in detail above. Persons skilled in the art may make variations and modifications to the present invention in terms of the specific implementations and application scopes according to the ideas of the embodiments of the present invention. Therefore, the specification shall not be construed as a limit to the present invention.

What is claimed is:

1. A node aggregation system for implementing a symmetric multi-processing system, comprising at least one node aggregation module, at least one service network interface module and at least one computing node cluster, wherein the computing node cluster comprises at least one computing node;
the computing node cluster forms a computing resource pool, and is configured to process a data service;
the node aggregation module constitutes an aggregation network domain, and is connected to all computing nodes in the computing node cluster through a first interface Interf1; and
the service network interface module constitutes a service network domain, and is connected to all the computing nodes in the computing node cluster through a second interface Interf2, and connected to an external input/output device through the second interface Interf2 or several interfaces different from the second interface Interf2.

2. The system according to claim 1, further comprising a feature node, wherein the node aggregation module is connected to the feature node in the system, and the feature node is configured to accelerate a process of processing the data service by the computing node in the system or add a function to the system.

3. The system according to claim 2, wherein several feature nodes form a node domain, and are connected to the node aggregation module through interfaces, and the node domain is configured to accelerate the process of processing the data service by the computing node in the system or add a function to the system.

4. The system according to claim 2, wherein the feature node comprises a solid state disk node, and is configured for system mirror and system cache.

5. The system according to claim 2, wherein the feature node comprises a database acceleration node, and is configured to assist the computing node to process a particular computing function during processing of a database service.

6. The system according to claim 2, wherein the feature node comprises a security acceleration node, and is configured to assist the computing node in the computing node cluster to process a security algorithm.

7. The system according to claim 1, wherein the first interface Interf1 comprises a private interface or an InfiniBand interface.

8. A node aggregation system for implementing a symmetric multi-processing system, comprising at least one node aggregation module, an input/output device and at least one computing node cluster, wherein the computing node cluster comprises at least one computing node;
the computing node cluster forms a computing resource pool, and is configured to process a data service;
the node aggregation module constitutes an aggregation network domain, and is connected to all computing nodes in the computing node cluster through a same interface, and connected to the input/output device through the same interface or other interfaces different from the same interface.

9. The system according to claim 8, further comprising several feature nodes, wherein the node aggregation module is connected to the feature node in the system, and the feature node is configured to accelerate a process of processing the data service by the computing node in the system or add a function to the system.

10. The system according to claim 9, wherein the several feature nodes form a node domain, and are connected to the node aggregation module through interfaces, and the node domain is configured to accelerate the process of processing the data service by the computing node in the system or add a function to the system.

11. The system according to claim 9, wherein the feature node comprises a solid state disk node, and is configured for system mirror and system cache.

12. The system according to claim 9, wherein the feature node comprises a database acceleration node, and is configured to assist the computing node to process a particular computing function during processing of a database service.

13. The system according to claim 9, wherein the feature node comprises a security acceleration node, and is configured to assist the computing node in the computing node cluster to process a security algorithm.

14. The system according to claim 8, wherein the converged interface comprises a private interface or an InfiniBand interface.

15. The system according to claim 8, wherein an external input/output device comprises a core switch of a data exchange center, a fibre channel array and an input/output expansion subrack.
